(19) United States
(12) Patent Application Publication
(10) Pub. No.: US 2025/0148271 A1
(43) Pub. Date: May 8, 2025

(54) Adaptive Minimum Voltage Aging Margin Prediction Method and Adaptive Minimum Voltage Aging Margin Prediction System Capable of Providing Satisfactory Prediction Accuracy

(71) Applicant: MEDIATEK INC., Hsinchu City (TW)

(72) Inventors: Yu-Lin Yang, Hsinchu City (TW); Po-Chao Tsao, Hsinchu City (TW); Hsiang-An Chen, Hsinchu City (TW); Chin-Wei Lin, Hsinchu City (TW); Ming-Cheng Lee, Hsinchu City (TW); Tung-Hsing Lee, Hsinchu City (TW)

(73) Assignee: MEDIATEK INC., Hsinchu City (TW)

(21) Appl. No.: 18/915,358

(22) Filed: Oct. 15, 2024

Related U.S. Application Data
(60) Provisional application No. 63/595,775, filed on Nov. 3, 2023.

(51) Int. Cl. G06N 3/0475

(52) U.S. Cl. CPC G06N 3/0475

(57) ABSTRACT

An adaptive minimum voltage aging margin prediction method includes acquiring characteristic data of a plurality of dies in a testing line, predicting a wear-out failure rate of each module of the plurality of dies according to the characteristic data by using a neural network, and predicting a minimum voltage aging margin of the each module according to the wear-out failure rate of the each module by using the neural network.

### CROSS REFERENCE TO RELATED APPLICATIONS

This application claims the benefit of U.S. Provisional Application No. 63/595,775, filed on Nov. 3, 2023. The content of the application is incorporated herein by reference.

### BACKGROUND

With the rapid advancement of technologies, various integrated circuits or chips are adopted in our daily life. An integrated circuit is a semiconductor that contains multiple electronic components interconnected to form a complete electronic function. The integrated circuits are the most essential part of all electronic products. Specifically, since the integrated circuit contains multiple electronic components, the integrated circuit may be aged over time. When the integrated circuit is aged, the aging electronic products require more driving voltages.

Currently, a minimum voltage for driving the integrated circuit can be predicted by introducing a fixed (or say, constant) aging margin gap to an original minimum voltage for all dies. However, since the minimum voltages for driving different integrated circuits or different dies are different, introducing the fixed aging margin gap for all dies may decrease the prediction accuracy. As a result, since the prediction accuracy of the minimum voltages used for driving the integrated circuits or dies is poor, power consumption for driving the integrated circuits may be increased.

Therefore, developing a minimum voltage aging margin prediction system capable of proving satisfactory prediction accuracy for various chips or dies is an important design issue.

### SUMMARY

In an embodiment of the present invention, an adaptive minimum voltage aging margin prediction method is disclosed. The adaptive minimum voltage aging margin prediction method comprises acquiring characteristic data of a plurality of dies in a testing line, predicting a wear-out failure rate of each module of the plurality of dies according to the characteristic data by using a neural network, and predicting a minimum voltage aging margin of the each module according to the wear-out failure rate of the each module by using the neural network.

In another embodiment of the present invention, an adaptive minimum voltage aging margin prediction system is disclosed. The adaptive minimum voltage aging margin prediction system comprises a die data source and a neural network coupled to the die data source. The neural network acquires characteristic data of a plurality of dies in a testing line from the die data source. The neural network predicts a wear-out failure rate of each module of the plurality of dies according to the characteristic data. The neural network predicts a minimum voltage aging margin of the each module according to the wear-out failure rate of the each module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an adaptive minimum voltage aging margin prediction system according to an embodiment of the present invention.

FIG. 2 shows signal flows of a testing line of the adaptive minimum voltage aging margin prediction system in FIG. 1.

FIG. 3 is an illustration of partitioning the plurality of dies into a plurality of groups by a neural network of the adaptive minimum voltage aging margin prediction system in FIG. 1.

FIG. 4 is a flow chart of performing an adaptive minimum voltage aging margin prediction method by the adaptive minimum voltage aging margin prediction system in FIG. 1.

### DETAILED DESCRIPTION

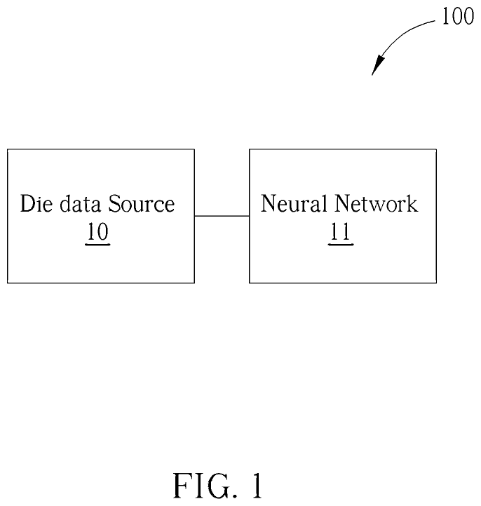

FIG. 1 is a block diagram of an adaptive minimum voltage aging margin prediction system 100 according to an embodiment of the present invention. The adaptive minimum voltage aging margin prediction system 100 includes a die data source 10 and a neural network 11. The die data source 10 can include at least one testing node in a testing line of a wafer. The neural network 11 is coupled to the die data source 10. The neural network 11 can be any artificial intelligence (AI) network. For example, the neural network 11 can include a recurrent neural network or a convolutional neural network training model. In the adaptive minimum voltage aging margin prediction system 100, the neural network 11 can acquire characteristic data of a plurality of dies in the testing line from the die data source 10. Then, the neural network 11 can predict a wear-out failure rate of each module of the plurality of dies according to the characteristic data. The neural network 11 can further predict a minimum voltage aging margin of each module according to the wear-out failure rate of each module. Here, the “minimum voltage aging margin” can be regarded as an additional voltage requirement when the chip is aged. In other words, the minimum voltage for driving each module can be determined by adding the minimum voltage aging margin to a base minimum voltage of each module. Instead of assigning a fixed minimum voltage aging margin to different dies, the adaptive minimum voltage aging margin prediction system 100 can adaptively adjust the additional voltage requirement for various modules or various dies. In other words, in the adaptive minimum voltage aging margin prediction system 100, minimum voltage aging margins of different modules or different dies are different. Details of predicting the minimum voltage aging margin are illustrated below.

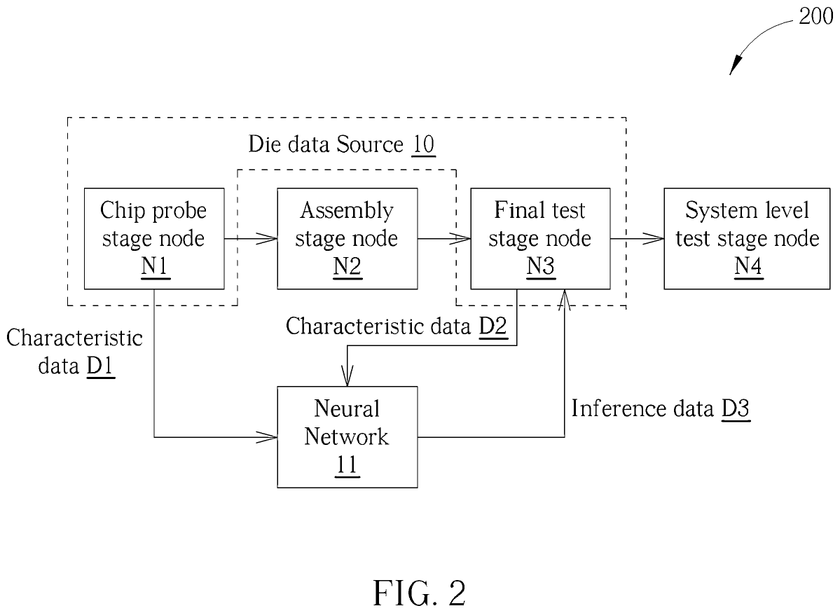

FIG. 2 shows signal flows of the testing line of the adaptive minimum voltage aging margin prediction system 100. To avoid ambiguity, the adaptive minimum voltage aging margin prediction system in FIG. 2 is called as the adaptive minimum voltage aging margin prediction system 200 hereafter. In FIG. 2, the testing line can include a plurality of nodes. For example, the testing line of the wafer can include a chip probe (CP) stage node N1, an assembly stage node N2, a final test (FT) stage node N3, and a system level test stage node N4. In an embodiment, the die data source 10 can include the CP stage node N1 or the FT stage node N3. Therefore, the characteristic data of the plurality of dies can be acquired from the CP stage node N1 or the FT stage node N3 of the testing line. When the characteristic data is acquired from the CP stage node N1, the neural network 11 can be trained by the CP stage node N1. Alternatively, when the characteristic data is acquired from the FT stage node N3, the neural network 11 can be trained by the FT stage node N3. In another embodiment, the die data source 10 can include the CP stage node N1 and the FT stage node N3. Therefore, the characteristic data of the plurality of dies can be acquired from the CP stage node N1 and the FT stage node N3 of the testing line. The neural network 11 can be trained by the CP stage node N1 and the FT stage node N3.

In the adaptive minimum voltage aging margin prediction system 200, the neural network 11 can generate inference data (i.e., aging margin voltage). For example, when the computing capability of the neural network 11 is sufficient, the neural network 11 can generate the inference data of predicting the minimum voltage aging margin of each module in real-time when the characteristic data is received by the neural network 11. For example, when the computing capability of the neural network 11 is insufficient, the neural network 11 can generate the inference data of predicting the minimum voltage aging margin of each module off-line after the characteristic data is received by the neural network 11. The characteristic data can include at least one physical feature of dies, such as a temperature, an aging level, or a power leakage level.

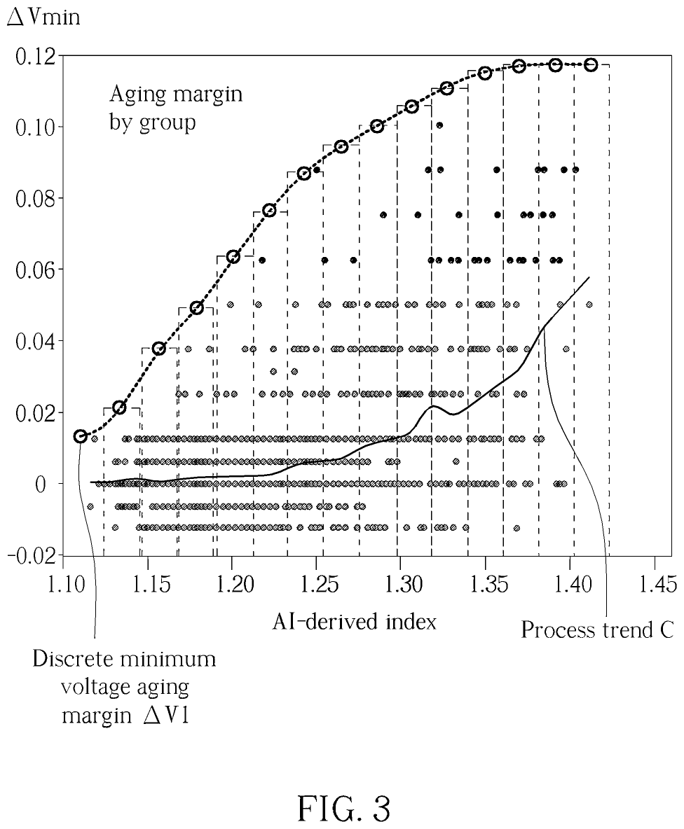

FIG. 3 is an illustration of partitioning the plurality of dies into a plurality of groups by the neural network 11 of the adaptive minimum voltage aging margin prediction system 100. As previously mentioned, the neural network 11 can acquire the characteristic data of dies from the die data source 10. Then, the neural network 11 can partition the plurality of dies into a plurality of groups according to the wear-out failure rate of each module of the plurality of dies. For example, FIG. 3 can be regarded as an aging distribution for a plurality of dies. X-axis is denoted as an AI-derived index. Values of the AI-derived index can be regarded as boundaries of the plurality of groups. For example, a group is determined according to an AI-derived index ranging from 1.10 to 1.125. Another group is determined according to an AI-derived index ranging from 1.125 to 1.15. Further, y-axis is denoted as a discrete minimum voltage aging margin axis ΔVmin. Then, the neural network 11 can predict the minimum voltage aging margin of each module by mapping each group of the plurality of groups into the discrete minimum voltage aging margin axis ΔVmin. For example, the neural network 11 can predict the minimum voltage aging margin as a discrete minimum voltage aging margin ΔV1 by mapping the group with the AI-derived index ranging from 1.10 to 1.125 to the discrete minimum voltage aging margin axis ΔVmin. By doing so, the computational complexity of predicting the minimum voltage aging margin can be reduced. Since the neural network 11 can acquire a base minimum voltage of each module according to the characteristic data of the plurality of dies, the neural network 11 can predict the minimum voltage of each module by adding the minimum voltage aging margin to the base minimum voltage of each module. Further, in FIG. 3, the neural network 11 can acquire a process trend C of the plurality of dies according to an aging distribution of the plurality of dies. The process trend C can be further adjusted according to the aging distribution of dies. FIG. 3 illustrates an embodiment of predicting the minimum voltage aging margins for different groups. However, the present invention is not limited thereto. Any technology or hardware modification falls into the scope of the present invention.

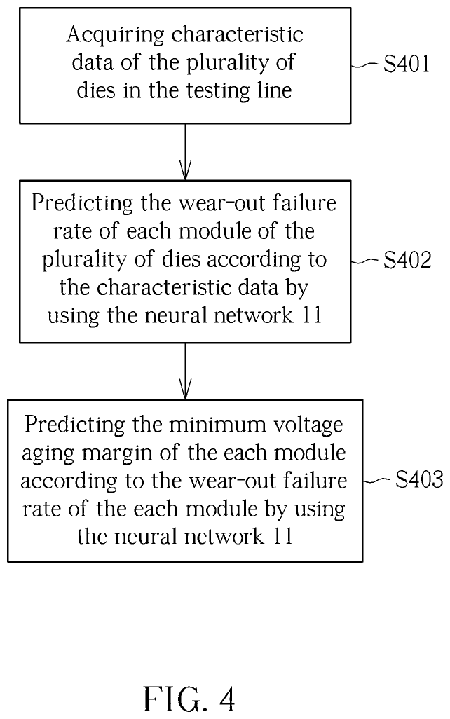

FIG. 4 is a flow chart of performing an adaptive minimum voltage aging margin prediction method by the adaptive minimum voltage aging margin prediction system 100. The adaptive minimum voltage aging margin prediction method includes step S401 to step S403. Any technology or hardware modification falls into the scope of the present invention. Step S401 to step S403 are illustrated below.
step S401: acquiring characteristic data of the plurality of dies in the testing line;
step S402: predicting the wear-out failure rate of each module of the plurality of dies according to the characteristic data by using the neural network 11;
step S403: predicting the minimum voltage aging margin of the each module according to the wear-out failure rate of the each module by using the neural network 11.

Details of step S401 to step S403 are previously illustrated. Thus, they are omitted here. In the adaptive minimum voltage aging margin prediction system 100, since the neural network is introduced for individually predicting the minimum voltage aging margin of each module according to the wear-out failure rate of each module, the minimum voltage aging margins for different modules or different dies are different. Therefore, the minimum voltage for driving each module of dies can be accurately predicted. As a result, even if chips are aged, power consumption of the chips can still be reduced.

To sum up, the present invention discloses an adaptive minimum voltage aging margin prediction system and an adaptive minimum voltage aging margin prediction method. The adaptive minimum voltage aging margin prediction method can be used for predicting the minimum voltage aging margin. The neural network can be introduced for individually predicting the minimum voltage aging margin of each module according to the wear-out failure rate of each module. Therefore, the minimum voltage aging margins of different modules or different dies are different. In other words, instead of assigning the fixed minimum voltage aging margin to different dies, the adaptive minimum voltage aging margin prediction system can adaptively adjust the additional voltage requirement for various modules or various dies. Therefore, the minimum voltage for driving each module of dies can be accurately predicted. As a result, even if chips are aged, power consumption of the chips can still be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adaptive minimum voltage aging margin prediction method comprising:
acquiring characteristic data of a plurality of dies in a testing line;
predicting a wear-out failure rate of each module of the plurality of dies according to the characteristic data by using a neural network; and
predicting a minimum voltage aging margin of the each module according to the wear-out failure rate of the each module by using the neural network.

2. The method of claim 1, wherein the characteristic data of the plurality of dies is acquired from a chip probe (CP) stage node or a final test (FT) stage node of the testing line.

3. The method of claim 1, wherein the characteristic data of the plurality of dies is acquired from a chip probe (CP) stage node and a final test (FT) stage node of the testing line, and the neural network is trained by the CP stage node and the FT stage node.

4. The method of claim 1, further comprising:
generating inference data of predicting the minimum voltage aging margin of the each module by the neural network in real-time when the characteristic data is received by the neural network.

5. The method of claim 1, further comprising:
outputting inference data of predicting the minimum voltage aging margin of the each module by the neural network off-line after the characteristic data is received by the neural network.

6. The method of claim 1, wherein minimum voltage aging margins of different modules or different dies are different.

7. The method of claim 1, further comprising:
acquiring a base minimum voltage of the each module according to the characteristic data of the plurality of dies; and
generating a predicted minimum voltage of the each module by adding the minimum voltage aging margin to the base minimum voltage of the each module.

8. The method of claim 1, further comprising:
partitioning the plurality of dies into a plurality of groups by the neural network according to the wear-out failure rate of each module of the plurality of dies.

9. The method of claim 8, wherein the minimum voltage aging margin of the each module is predicted by mapping the each group of the plurality of groups into a discrete minimum voltage aging margin axis by the neural network.

10. The method of claim 1, further comprising:
acquiring a process trend of the plurality of dies according to an aging distribution of the plurality of dies by the neural network.

11. An adaptive minimum voltage aging margin prediction system comprising:
a die data source; and
a neural network coupled to the die data source;
wherein the neural network acquires characteristic data of a plurality of dies in a testing line from the die data source, the neural network predicts a wear-out failure rate of each module of the plurality of dies according to the characteristic data, and the neural network predicts a minimum voltage aging margin of the each module according to the wear-out failure rate of the each module.

12. The system of claim 11, wherein the die data source comprises a chip probe (CP) stage node or a final test (FT) stage node, the characteristic data of the plurality of dies is acquired from the CP stage node or the FT stage node of the testing line.

13. The system of claim 11, wherein the die data source comprises a chip probe (CP) stage node and a final test (FT) stage node, the characteristic data of the plurality of dies is acquired from the CP stage node and the FT stage node of the testing line, and the neural network is trained by the CP stage node and the FT stage node.

14. The system of claim 11, wherein the neural network generates inference data of predicting the minimum voltage aging margin of the each module in real-time when the characteristic data is received by the neural network.

15. The system of claim 11, wherein the neural network generates inference data of predicting the minimum voltage aging margin of the each module in off-line after the characteristic data is received by the neural network.

16. The system of claim 11, wherein minimum voltage aging margins of different modules or different dies are different.

17. The system of claim 11, wherein the neural network acquires a base minimum voltage of the each module according to the characteristic data of the plurality of dies, and the neural network generates a predicted minimum voltage of the each module by adding the minimum voltage aging margin to the base minimum voltage of the each module.

18. The system of claim 11, wherein the neural network partitions the plurality of dies into a plurality of groups according to the wear-out failure rate of each module of the plurality of dies.

19. The system of claim 18, wherein the minimum voltage aging margin of the each module is predicted by mapping the each group of the plurality of groups into a discrete minimum voltage aging margin axis by the neural network.

20. The system of claim 11, wherein the neural network acquires a process trend of the plurality of dies according to an aging distribution of the plurality of dies.
